(19) United States
(12) Patent Application Publication
(10) Pub. No.: US 2020/0070808 A1
(43) Pub. Date: Mar. 5, 2020

(54) HYBRID VEHICLE

(71) Applicant: TOYOTA JIDOSHA KABUSHIKI KAISHA, Toyota-shi (JP)

(72) Inventor: Atsuharu OTA, Mishima-shi (JP)

(73) Assignee: TOYOTA JIDOSHA KABUSHIKI KAISHA, Toyota-shi (JP)

(21) Appl. No.: 16/451,712

(22) Filed: Jun. 25, 2019

(30) Foreign Application Priority Data
Aug. 31, 2018 (JP) 2018-162376

(51) Int. Cl. B60W 20/13; B60K 6/26; B60W 10/06; B60W 10/08; B60K 6/28; B60K 1/04; F02N 11/04; F02N 11/08; F02D 9/02; F02D 41/02

(52) U.S. Cl. CPC B60W 20/13; B60K 2001/005; B60W 10/06; B60W 10/08; B60K 6/28; B60K 1/04; F02N 11/04; F02N 11/0833; F02D 9/02; F02D 41/021; B60W 2510/246; B60W 2510/244; B60W 2710/0605; B60W 2710/08; B60Y 2200/92; B60Y 2306/05; B60Y 2300/192; B60W 2710/0627; B60W 2710/0677; B60K 6/26

(57) ABSTRACT

A hybrid vehicle in which an electric storage device can be cooled during propulsion in an electric vehicle mode. In the hybrid vehicle, the battery supplies electricity to a drive motor when the hybrid vehicle is powered by the drive motor in an electric vehicle mode while stopping the engine. The battery is cooled by an intake air flowing through an intake passage of the engine. A detector detects a temperature of the battery, and a controller operates a motor-generator when the temperature of the battery exceeds a first threshold value during propulsion in the electric vehicle mode.

### CROSS REFERENCE TO RELATED APPLICATIONS

The present application claims the benefit of priority to Japanese Patent Application No. 2018-162376 filed on Aug. 31, 2018 with the Japanese Patent Office, the entire contents of which are incorporated herein by reference in its entirety.

### BACKGROUND

### Field of the Disclosure

Embodiments of the disclosure relate to the art of a hybrid vehicle in which a battery for supplying electricity to a drive motor is cooled by air flowing through an intake passage of an engine.

### Discussion of the Related Art

JP-A-2003-178814 describes a battery cooling device for a vehicle having an engine. According to the teachings of JP-A-2003-178814, the battery supplies electricity to electronic devices arranged in the vehicle such as an audio device, an air conditioner, an alternator, a starter motor and so on. In recent years, power consumptions of those electronic devices have increased with an improvement in performance. For this reason, a capacity of the battery is increased, a terminal voltage is raised, and a number of cells is reduced. However, as a result of such improvement of the performance of the battery, heat generation of the battery due to charging and discharging of the battery is increased. If temperature of the battery exceeds an upper limit level, performance of the battery may be reduced. In order to prevent such reduction in performance of the battery, according to the teachings of JP-A-2003-178814, the battery is arranged integrally with the intake passage of the engine so that the battery is cooled directly by the air flowing through the intake passage.

In a hybrid vehicle having an engine and a motor, an operating mode can be selected from an engine mode in which the hybrid vehicle is powered by the engine, and an electric vehicle mode in which the hybrid vehicle is powered by the motor while stopping the engine. If the cooling device taught by JP-A-2003-178814 is applied to the hybrid vehicle of this kind, the battery may be cooled during propulsion in the engine mode, but may not be cooled during propulsion in the electric vehicle mode.

### SUMMARY

Aspects of embodiments of the present disclosure have been conceived noting the foregoing technical problems, and it is therefore an object of the present disclosure to provide a hybrid vehicle in which an electric storage device can be cooled during propulsion in an electric vehicle mode.

The exemplary embodiment of the present disclosure relates to a hybrid vehicle comprising: an engine; a drive motor; a cranking device that rotates the engine; and an electric storage device that supplies electricity to the drive motor when the hybrid vehicle is propelled in an electric vehicle mode in which the hybrid vehicle is propelled by a drive force generated by the drive motor while stopping the engine. In the hybrid vehicle, the electric storage device is cooled by an intake air flowing through an intake passage of the engine. in order to achieve the above-explained objective, according to the exemplary embodiment of the present disclosure, the hybrid vehicle is further provided with: a detector that detects a temperature of the electric storage device; and a controller that controls the engine, the drive motor, and the cranking device. The controller is configured to operate the cranking device when the temperature of the electric storage device exceeds a first threshold value during propulsion in the electric vehicle mode.

In a non-limiting embodiment, the hybrid vehicle may further comprise a state of charge level detector that detects a state of charge level of the electric storage device. The controller may be further configured to: operate the cranking device and execute a firing of the engine by supplying fuel to the engine, when the state of charge level of the electric storage device is lower than the second threshold value; and crank the engine by operating the cranking device while stopping fuel supply to the engine when the state of charge level of the electric storage device is higher than a second threshold value.

In a non-limiting embodiment, the hybrid vehicle may further comprise a throttle valve that is arranged in the intake passage. The controller may be further configured to increase an opening degree of the throttle valve wider than an opening degree of a case in which the engine is idled when cranking the engine.

In a non-limiting embodiment, the controller may be further configured to change an output power of the engine in accordance with a restriction of an input power to the electric storage device during execution of the firing of the engine.

In a non-limiting embodiment, the cranking device may include a motor-generator that is connected to the engine, and electricity generated by the motor-generator may be accumulated in the electric storage device.

Thus, according to the exemplary embodiment of the present disclosure, the engine is rotated by the cranking device when the temperature of the electric storage device exceeds the first threshold value. According to the exemplary embodiment of the present disclosure, therefore, the electric storage device may be cooled even in the electric vehicle mode.

### BRIEF DESCRIPTION OF THE DRAWINGS

Features, aspects, and advantages of exemplary embodiments of the present disclosure will become better understood with reference to the following description and accompanying drawings, which should not limit the invention in any way.

FIG. 1 is a schematic illustration schematically showing a structure of a hybrid vehicle according to the embodiment of the present disclosure;

FIG. 2 is a schematic illustration showing a structure of an intake passage of the engine;

FIG. 3 is a flowchart showing one example of a routine executed by a controller of the hybrid vehicle to cool a battery during propulsion in the electric vehicle mode;

FIG. 4 is a flowchart showing another example of a routine to increase an opening degree of a throttle valve during motoring of the engine;

FIG. 5 is a flowchart showing still another example of a routine to change an output torque of the engine depending on a restriction on an input power to a battery during firing of the engine; and

FIG. 6 is a map determining a relation between an output power of the engine and a required drive force.

### DETAILED DESCRIPTION OF THE PREFERRED EMBODIMENT(S)

Preferred embodiments of the present disclosure will now be explained with reference to the accompanying drawings. Turing now to FIG. 1, there is schematically shown a structure of a hybrid vehicle (as will be simply called the “vehicle” hereinafter) 1 according to the exemplary embodiment of the present disclosure. The vehicle 1 comprises an engine 2, a first motor 4, a second motor 5 as a drive motor, a secondary battery (as will be simply called the “battery” hereinafter) 6 as an electric storage device, a power transmission unit 7, a transmission 8, a differential gear unit 9, a detector 10, and a controller 11. In the vehicle 1, the engine 2 is disposed in a front section of the vehicle 1, and output powers of the engine 2 and the second motor 5 are distributed to drive wheels 3.

A motor-generator may be adopted as the first motor 4, and the first motor 4 is connected to the engine 2 through the power transmission unit 7. The first motor 4 serves mainly as a cranking device (or a motoring device) to generate a torque to rotate the engine 2, and also serves as a generator to generate electricity when rotated by the engine 2. The second motor 5 is also a motor-generator that generates a drive force to propel the vehicle 1, and that regenerates energy during deceleration of the vehicle 1. For example, a permanent magnet type synchronous motor may be used as the second motor 5. Specifically, the engine 2 is a thermal engine that generates a kinetic power by burning air/fuel mixture. The engine 2 comprises a plurality of cylinders, an intake passage, and an exhaust pipe for discharging exhaust gas from the cylinders.

For example, a power split mechanism including a planetary gear unit may be adopted as the power transmission unit 7. In the planetary gear unit of the power transmission unit 7, a carrier as a first rotary element is connected to the engine 2, a sun gear as a second rotary element is connected to the first motor 4, and a ring gear as a third rotary element serves as an output member. The third rotary element is connected to the second motor 5 so that the electricity generated by the first motor 4 is supplied to the second motor 5. The third rotary element as the output member of the power transmission unit 7 delivers torque to an input shaft of the transmission 8. That is, the output power of the engine 2 is distributed to the first motor 4 and the output member through the power split mechanism. As described, the first motor 4 generates electricity when rotated by the engine 2, and a resultant reaction force is applied to the second rotary element. That is, a rotational speed of the engine 2 is controlled by the first motor 4 in a fuel efficient manner, and a synthesized torque of the output torque of the engine 2 and the reaction torque of the first motor 4 is delivered to the transmission 8. According to the exemplary embodiment, not only a single-pinion planetary gear unit but also a double-pinion planetary gear unit may be employed in the power split mechanism.

The power split mechanism may be provided with an engagement device to stop a rotation of an output shaft of the engine 2 or a predetermined rotary member connected to the output shaft of the engine 2. For example, a one-way clutch may be adopted as the engagement device to prevent an inverse rotation of the first rotary element connected to the engine 2, or an engine shaft connecting the engine 2 to the first rotary element. Specifically, the one-way clutch stops the rotation of the first rotary element or the engine shaft while receiving a reaction force resulting from rotating the first motor 4 inversely. Consequently, the output torque of the first motor 4 is delivered to the third rotary element in the forward direction. That is, the power split mechanism may be adapted to establish a dual-motor mode in which both of the first motor 4 and the second motor 5 are operated as drive motor to propel the vehicle 1 in an electric vehicle mode.

Instead, the power transmission unit 7 may be omitted. In this case, the first motor 4 is connected directly to the engine 2, and the second motor 5 is operated by the electricity generated by the first motor 4. A drive force generated by the second motor 5 is delivered to the output member. That is, the vehicle 1 may also be configured as a series hybrid vehicle. In this case, the operating mode of the vehicle 1 is switched between a first electric vehicle mode in which the vehicle 1 is propelled while activating the engine 2, and a second electric vehicle mode in which the vehicle 1 is propelled while stopping the engine 2, in accordance with a state of charge (to be abbreviated as “SOC” hereinafter) level of the battery 6.

The transmission 8 delivers torque transmitted from the power transmission unit 7 to the differential gear unit 9 while changing a magnitude of the torque. To this end, for example, a geared transmission, and a continuously variable transmission that changes a speed ratio continuously may be adopted as the transmission 8. Preferably, the transmission 8 is provided with a clutch device that is engaged to transmit torque and that is disengaged to interrupt torque transmission thereby bringing the transmission 8 into a neutral stage. Here, it is to be noted that the transmission 8 may be omitted. The torque delivered to the differential gear unit 9 is distributed to each of the drive wheels 3.

The battery 6 supplies the electricity to the second motor 5 during propulsion in the electric vehicle mode, and the battery 6 may be charged not only with the electricity generated by the first motor 4 but also with the electricity supplied from an external source. Instead, a capacitor may also be employed as the battery 6. The detector 10 detects a temperature, an output voltage, and an output current of the battery 6. Information detected by the detector 9 is transmitted to a controller 11 so that the controller 11 estimates an SOC level of the battery 6 based on the information transmitted from the detector 9. That is, the detector 10 and the controller 11 may serve as a state of charge level detector of the embodiment.

The operating mode of the vehicle 1 may be selected from the engine mode, the electric vehicle mode, and a series mode in accordance with a vehicle speed, an opening degree of an electronic throttle valve or a depression of an accelerator pedal, and an SOC level of the battery 6. In the engine mode, the vehicle 1 is powered only by the engine 2. In the electric vehicle mode, the engine 2 is stopped, and the second motor 5 is operated by the electricity generated by the first motor 4 to generate drive force to propel the vehicle 1. In the series mode, the engine 2 is activated, the battery 6 is charged with the electricity generated by the first motor 4, and the second motor 5 is operated by the electricity supplied from the battery 6 to generate drive force to propel the vehicle 1. When shifting the operating mode from the electric vehicle mode to the engine mode or the series mode, the first motor 4 is driven to startup the engine 2.

The controller 11 has a microcomputer as its main constituent, and the controller 11 is configured to shift the operating mode of the vehicle 1 by controlling the engine 2, the first motor 4, and the second motor 5. To this end, the controller 11 executes calculation based on data transmitted from various sensors and data installed in advance, and transmits a calculation result in the form of command signal. For example, an opening degree of the accelerator, a speed of the engine 2, a speed of the vehicle 1, an SOC level of the battery 6 and so on are sent to the controller 11. The data installed in the controller 11 includes a map for selecting the operating mode based on an opening degree of the accelerator and a speed of the vehicle 1, a map for determining a relation between a required drive force and an opening degree of the accelerator and so on. Specifically, the controller 11 transmits an ignition signal, a fuel injection signal, and a drive signal to activate a starter to startup the engine 2, signals to start and stop the first motor 4 and the second motor 5, a signal to start generation of electricity, a signal to control an opening degree of the throttle valve of the engine 2, and so on.

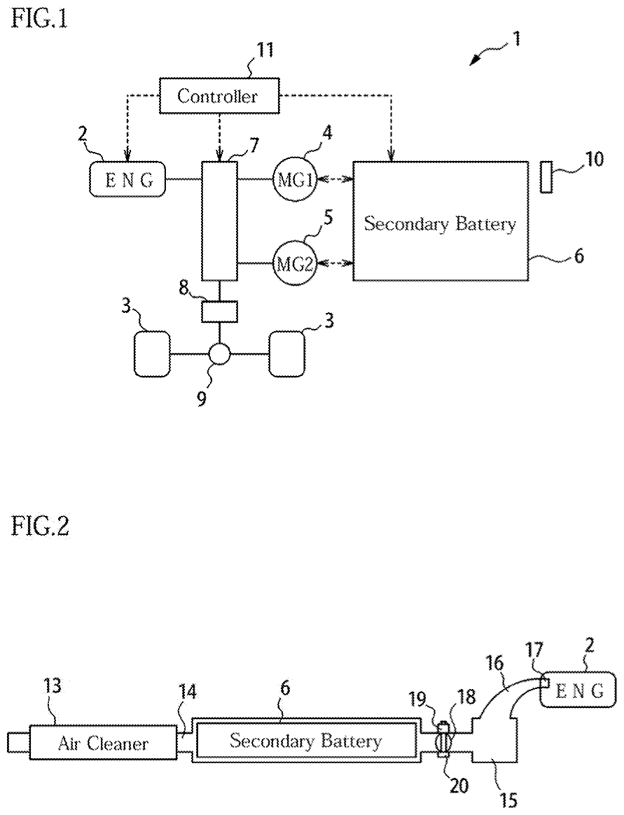

Turing to FIG. 2, there is shown one example of a structure of the intake passage of the engine 2. As illustrated in FIG. 2, air is introduced to a combustion chamber of each cylinder of the engine 2 through the intake passage 14 via an air cleaner 13, an intake collector (or a surge tank) 15, an intake manifold 16, and an intake valve 17. The battery 6 is arranged in the intake passage 14 so that the air flows around the battery 6 thereby cooling the battery 6. In the example shown in FIG. 2, specifically, the battery 6 is disposed between the air cleaner 13 and the intake collector 15. However, a position of the battery 6 may be altered arbitrarily as long as the heat of the battery 6 can be exchanged with the air flowing through the intake passage 14. Optionally, a cooling fan driven by the air flowing through the intake passage 14 may be arranged in the intake passage 14 to cool the battery 6. In this case, the air is introduced toward the battery 6 through a duct or by the fan, and the battery 6 is cooled directly by the air. Thus, according to the exemplary embodiment, the battery 6 is cooled utilizing the air flowing through the intake passage 14.

In the intake passage 14, a throttle valve 18 is disposed upstream of the intake collector 15. An opening degree of the throttle valve 18 is changed by a throttle motor 19, and the controller 11 controls an opening degree of the throttle valve 18 in accordance e.g., with a depression of the accelerator pedal by operating the throttle motor 19. That is, an opening degree of the throttle valve 18 may also be controlled by the controller 11 independently from an operation of the accelerator pedal. In order to detect an opening degree of the throttle valve 18, a throttle opening sensor 20 is arranged in the intake passage 14, and a detection signal of an opening degree of the throttle valve 18 is sent from the throttle opening sensor 20 to the controller 11.

The battery 6 is a battery pack comprising a sealed casing, and a plurality of cells held on the casing. In the battery pack, heat of the cell is transported to an inner surface of the casing by the air circulated within the casing, and the heat thus transported to the casing is radiated from the casing to the ambient air as a result of temperature rise of the casing.

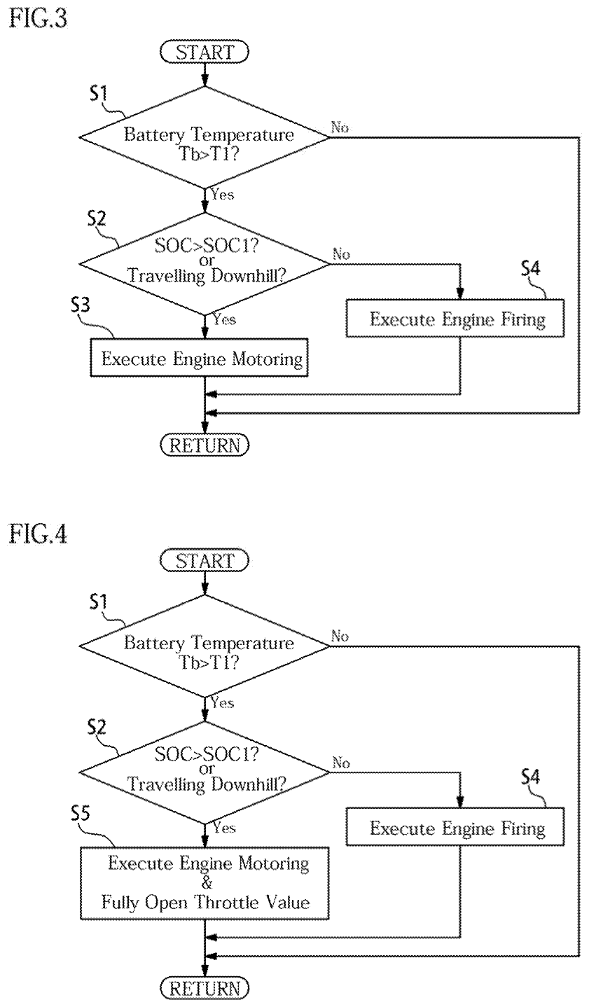

FIG. 3 shows one example of a routine to cool the battery 6 during propulsion in the electric vehicle mode in which the engine 2 is stopped. A determination of a shutdown of the engine 2 may be determined based on a fact that the ignition signal and the fuel injection signal are not transmitted in the current operating mode.

At step S1, it is determined whether a temperature Tb of the battery 6 exceeds a first threshold value T1. To this end, the temperature Tb of the battery 6 is observed at predetermined time intervals. If the temperature Tb of the battery 6 has not yet exceeded the first threshold value T1 so that the answer of step S1 is NO, the routine returns.

By contrast, if the temperature Tb of the battery 6 is higher than the first threshold value T1 so that the answer of step S1 is YES, the routine progresses to step S2 to determine whether an SOC level of the battery 6 exceeds a second threshold value SOC1 as a lower limit level.

If the SOC level of the battery 6 is higher than the second threshold value SOC1 so that the answer of step S2 is YES, the routine progresses to step S3 to execute a motoring or cranking of the engine 2. At step S3, specifically, the first motor 4 is driven to rotate the engine 2 while interrupting fuel supply to the engine 2. In this situation, optionally, an opening degree of the throttle valve 18 may be reduced e.g., to a degree of a case in which the engine 2 is idled. In this case, therefore, the engine 2 is rotated by the first motor 4 without burning the fuel. As a result, the battery 6 is cooled by the air introduced to the cylinders of the engine 2.

Thus, the motoring of the engine 2 is executed at step S3 in the case that the SOC level of the battery 6 is sufficiently high and hence the battery 6 is not necessarily to be charged. That is, when the SOC level of the battery 6 is sufficiently high during propulsion in the electric vehicle mode, the battery 6 can be cooled without consuming the fuel. In addition, a torque shock will not be generated even if the engine 2 is thus rotated passively and hence smooth propulsion of the vehicle 1 can be ensured. Further, since the engine is rotated without generating noise, quietness of the vehicle 1 can be ensured. Furthermore, since SOC level of the battery 6 is sufficiently high, the vehicle 1 is allowed to travel in the electric vehicle mode while cooling the battery 6 over a long distance.

Alternatively, at step S2, it is also possible to determine whether the vehicle 1 travels downhill. In this case, if the vehicle 1 is currently travelling on a downhill so that the answer of step S2 is YES, the routine progresses to step S3 to execute the motoring of the engine 2. For example, such determination may be made based on a fact that the battery 6 is charged with the electricity generated by the second motor 5 during propulsion in the electric vehicle mode without depressing the accelerator pedal. In other words, the answer of step S2 will be YES when a regenerative braking torque is established. Further, at step S2, it is also possible to determine whether the vehicle 1 is decelerated while establishing a regenerative braking torque. In this case, if the battery 6 is charged with the electricity generated by the second motor 5 so that the answer of step S2 is YES, the SOC level of the battery 6 is expected to be raised. Therefore, the routine progresses to step S3 to execute the motoring of the engine 2.

Otherwise, if the SOC level of the battery 6 is lower than the second threshold value SOC so that the answer of step S2 is NO, the routine progresses to step S4 to execute a firing of the engine 2. At step S4, specifically, the first motor 4 is driven to rotate the engine 2 while supplying the fuel to the engine 2. In this situation, an amount of fuel injection is adjusted to an amount possible to generate a minimum torque to propel the vehicle 1 while combusting the engine 2. In other words, an amount of fuel injection is adjusted e.g., to an amount possible to idle the engine 2. Consequently, the engine 2 is brought into a self-sustaining condition. As a result of thus activating the engine 2, the battery 6 is cooled by the intake air to the engine 2. In this case, the battery 6 can be cooled while charging the battery 6 with the electricity generated by the first motor 4 driven by the engine 2. For this reason, the operating mode may be shifted earlier to the electric vehicle mode again.

In addition, after shifting from the electric vehicle mode to the engine mode, a temperature of the intake air introduced to the engine 2 is raised as a result of heat exchange with the battery 6 on the way to the cylinders. For this reason, emission of unburnt gas can be reduced. Specifically, the unburnt gas sticking to the cylinders is lifted by the pistons during an exhaust process, and evaporated by the intake air of high temperature. For this reason, emission of hydrocarbon of high concentration can be reduced when starting the engine 2, even if a temperature of a catalyst is low.

In order to enhance the cooling effect for cooling the battery 6, according to the exemplary embodiment of the present disclosure, an opening degree of the throttle valve 18 may be increased to increase air intake during execution of the motoring of the engine 2. An example of a routine to increase air intake during motoring is shown in FIG. 4.

In the routine shown in FIG. 4, at step S5, the controller 11 increases an opening degree of the throttle valve 18 to be wider than an opening degree of a case of idling the engine 2. For example, at step S5, the throttle valve 18 is fully opened. As a result, an amount of the air introduced to the engine 2 is increased so that the battery 6 is cooled effectively. In this case, therefore, a power consumed to by the first motor 4 to rotate the engine 2 can be reduced. That is, the electric power supplied from the battery to the first motor 4 can be reduced.

The remaining steps of the routine shown in FIG. 4 are similar to those of the routine shown in FIG. 3. Further, according to the exemplary embodiment of the present disclosure, an output power of the engine 2 may be changed during execution of the firing at step S4 in accordance with a restriction on an input power to the battery 6 (i.e., an amount of space of the battery 6). An example of a routine to change the output power of the engine 2 during firing is shown in FIG. 5.

In the routine shown in FIG. 5, at step S6, the controller 11 changes an output power of the engine 2 in accordance with the restriction of an input power to the battery 6 during execution of the firing control of the engine 2.

Specifically, the restriction of an input power to the battery 6 is an upper limit value of the electric power possible to be accumulated in the battery 6, and for example, the upper limit value may be determined based on an SOC level and a temperature of the battery 6. That is, the upper limit value is set in such a manner that a voltage and an SOC level of the battery 6 will not be raised higher than upper limit levels due to overcharging. For example, the upper limit value of the input power to the battery 6 is small when the SOC level of the battery 6 is relatively high within the second threshold value SOC1 and when the temperature of the battery 6 is significantly high. By contrast, the upper limit value of the input power to the battery 6 is large when the SOC level of the battery 6 is relatively low within the second threshold value SOC1.

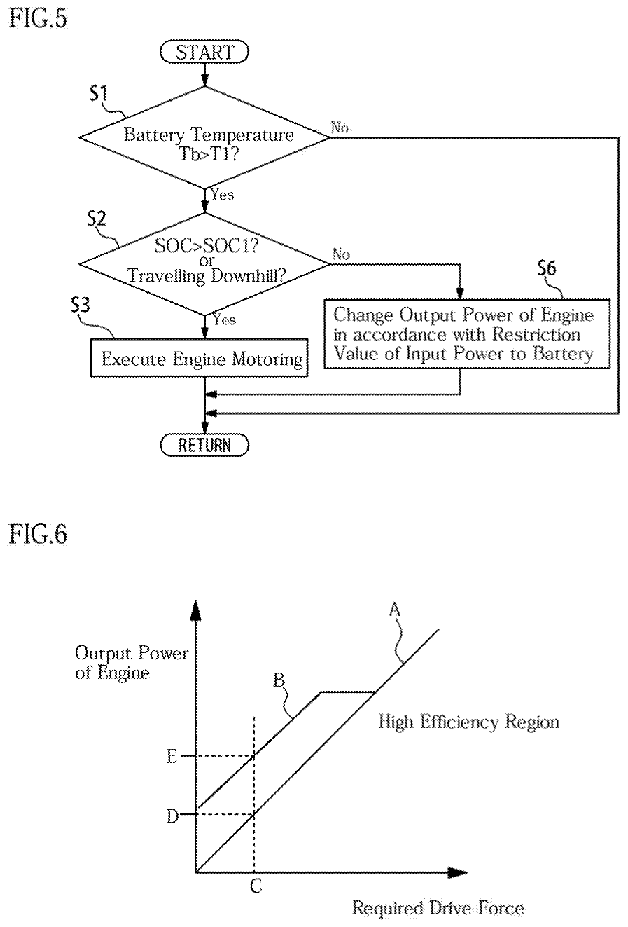

FIG. 6 shows an example of a map for determining an output power of the engine 2 in accordance with a required drive force. The required drive force may be obtained with reference to a map determining the required drive force based on an opening degree of the throttle valve 18 representing a drive demand and a speed of the vehicle 1. Then, the output power of the engine 2 is controlled in accordance with the required drive force thus determined.

In the vehicle 1, specifically, the controller 11 calculates the required drive force based on an actual opening degree of the throttle valve 18 and an actual speed of the vehicle 1 with reference to the above-mentioned map. Then, the controller 11 calculates a required engine torque to achieve the required drive force based e.g., on an effective diameter of a tire of the drive wheel 3, a gear ratio of a current gear stage of the transmission 8, and a final reduction ratio of the differential gear unit 9. The output power of the engine 2 is calculated by multiplying the required engine torque by an engine speed. As indicated by the line A in FIG. 6, the output power of the engine 2 is increased linearly in a fuel efficient manner with an increase in the required drive force. When the upper limit value of the input power to the battery 6 is large, the output power of the engine 2 is increased as indicated by the line B in FIG. 6.

By contrast, when the upper limit value of the input power to the battery 6 is small, the output power of the engine 2 is increased as indicated by the line A in FIG. 6. Specifically, in the case of increasing the output power of the engine 2 along the line B, the output power of the engine 2 is increased greater than that of the case in which the output power of the engine 2 is increased along the line A, so as to raise the SOC level of the battery 6 higher than the second threshold value SOC1.

For example, given that the required drive force is C and the upper limit value of the input power to the battery 6 is large, the output power of the engine 2 is increased to the point E shown in FIG. 6 which is greater than that at point D shown in FIG. 6. Consequently, an amount of air intake is increased with an increase in the output power of the engine 2 so that the battery 6 is cooled effectively. In addition, an amount of power generation by the first motor 4 is also increased with an increase in the output power of the engine 2 so that the input power to charge the battery 6 is increased. For this reason, the battery 6 can be charged amply and promptly, and the operating mode can be shifted to the electric vehicle mode earlier.

By contrast, given that the required drive force is C and the upper limit value of the input power to the battery 6 is small, the output power of the engine 2 is set to the point D which is smaller than that at point E. In this case, therefore, the battery 6 can be cooled while maintaining the SOC level of the battery 6. In addition, the engine 2 is allowed to be operated at an efficient speed (within a high efficient region) even if the required drive force is small.

Here, it is to be noted that the routine shown in FIG. 5 may be combined with the routine shown in FIG. 4. The remaining steps of the routine shown in FIG. 5 are similar to those of the routine shown in FIG. 3.

Although the above exemplary embodiments of the present disclosure have been described, it will be understood by those skilled in the art that the present disclosure should not be limited to the described exemplary embodiments, and various changes and modifications can be made within the scope of the present disclosure. For example, an optional starter motor may be employed to crank the engine 2 instead of the first motor 4. Further, when the vehicle 1 is decelerated without depressing the accelerator pedal and an expected regeneration amount is small, the engine 2 may also be cranked by an inertia force of the vehicle 1. Specifically, the vehicle 1 is provided with a clutch that is engaged to transmit the torque of the engine 2 to the drive wheels and that is disengaged to interrupt torque transmission. For example, the clutch is disengaged during propulsion in the electric vehicle mode. In this situation, when a temperature of the battery 6 exceeds the first threshold value while decelerating the vehicle 1, and the expected regeneration amount is small, the controller 11 engaged the clutch to rotate the engine 2 by the inertia force of the vehicle 1. Thus, the cranking device of the embodiment includes the clutch.

What is claimed is:

1. A hybrid vehicle comprising:
an engine;
a drive motor;
a cranking device that rotates the engine; and
an electric storage device that supplies electricity to the drive motor when the hybrid vehicle is propelled in an electric vehicle mode in which the hybrid vehicle is propelled by a drive force generated by the drive motor while stopping the engine,
wherein the electric storage device is cooled by an intake air flowing through an intake passage of the engine,
the hybrid vehicle further comprising:
a detector that detects a temperature of the electric storage device; and
a controller that controls the engine, the drive motor, and the cranking device,
wherein the controller is configured to operate the cranking device when the temperature of the electric storage device exceeds a first threshold value during propulsion in the electric vehicle mode.

2. The hybrid vehicle as claimed in claim 1, further comprising:
a state of charge level detector that detects a state of charge level of the electric storage device, and
wherein the controller is further configured to
operate the cranking device and execute a firing of the engine by supplying fuel to the engine, when the state of charge level of the electric storage device is lower than a second threshold value, and
crank the engine by operating the cranking device while stopping fuel supply to the engine when the state of charge level of the electric storage device is higher than the second threshold value.

3. The hybrid vehicle as claimed in claim 2, further comprising:
a throttle valve that is arranged in the intake passage, and
wherein the controller is further configured to increase an opening degree of the throttle valve wider than an opening degree of a case in which the engine is idled when cranking the engine.

4. The hybrid vehicle as claimed in claim 2, wherein the controller is further configured to change an output power of the engine in accordance with a restriction of an input power to the electric storage device during execution of the firing of the engine.

5. The hybrid vehicle as claimed in claim 3, wherein the controller is further configured to change an output power of the engine in accordance with a restriction of an input power to the electric storage device during execution of the firing of the engine.

6. The hybrid vehicle as claimed in claim 1,
wherein the cranking device includes a motor-generator that is connected to the engine, and
electricity generated by the motor-generator is accumulated in the electric storage device.

7. The hybrid vehicle as claimed in claim 2,
wherein the cranking device includes a motor-generator that is connected to the engine, and
electricity generated by the motor-generator is accumulated in the electric storage device.

8. The hybrid vehicle as claimed in claim 3,
wherein the cranking device includes a motor-generator that is connected to the engine, and
electricity generated by the motor-generator is accumulated in the electric storage device.

9. The hybrid vehicle as claimed in claim 4,
wherein the cranking device includes a motor-generator that is connected to the engine, and
electricity generated by the motor-generator is accumulated in the electric storage device.

10. The hybrid vehicle as claimed in claim 5,
wherein the cranking device includes a motor-generator that is connected to the engine, and
electricity generated by the motor-generator is accumulated in the electric storage device.
